(19) United States
(12) Patent Application Publication
(10) Pub. No.: US 2012/0067748 A1
(43) Pub. Date: Mar. 22, 2012

(54) Prophylaxis Paste Holder Dispenser with Multiple Prophylaxis Pastes

(76) Inventors: Peter Jung, Boulder, CO (US); Rachel Barton, Wildwood, MO (US); Michael Turner, Webster Groves, MO (US); Jeanette Gail Vargo, Wentzville, MO (US); Michael Schmitz, Ballwin, MO (US)

(21) Appl. No.: 12/884,897

(22) Filed: Sep. 17, 2010

(51) Int. Cl. A61C 19/06

(52) U.S. Cl. 206/63.5

(57) ABSTRACT

A dental prophylaxis paste holder dispenser comprises a first prophylaxis paste and a second prophylaxis paste. The first prophylaxis paste has a first material. The second prophylaxis paste has a second material. The first material has a first material property and the second material has a second material property. The first material property differs from the second material property.

### TECHNICAL FIELD

The present invention generally relates to a dental prophylaxis paste holder dispenser, and more specifically, to such a holder dispenser that contains multiple dental prophylaxis pastes having different properties.

### BACKGROUND OF THE INVENTION

Dental angles are used by dentists to clean and/or polish teeth. To accomplish this, dental angles carry dental finishing tools such as prophylaxis cups, or prophy cup.

Usually a dentist, hygienist, or other clinician uses prophylaxis paste, or prophy paste, in connection with the prophy cup in order to clean and/or polish a patient's teeth. Prophy paste is often held in a cylindrical single dose holder dispensers. A holder will contain a single type of paste. The clinician typically scoops the prophy cup into the prophy paste to retain a portion of the paste within the prophy cup. Thereafter, the prophy cup is rotated at high speed as it engages the patient's teeth. The prophy paste works with the prophy cup to remove plaque build up on a patient's teeth, stains on the patient's teeth, a biofilm on the patient's teeth, or to simply polish the patient's teeth.

A clinician typically assesses a patient's health needs based at least upon the condition of the patient's mouth and the patient's expectations of the treatment. Part of the assessment is based on an amount of stain present on the patient's teeth, as well as an amount of biofilm present on the patient's teeth. Additionally, the assessment may determine that the patient has restorative materials present due to previous dental work, hypersensitive teeth, or/and the patient is experiencing high levels of tooth decay on certain teeth.

Thus, it is not uncommon for a patient to have varying prophy paste needs. That is, a patient may have heavy staining on certain teeth, and/or only light stain buildup on other teeth, and/or dental restorative materials in certain areas of the mouth, and/or a few very sensitive teeth, and/or a few teeth with high levels of decay. Thus, a clinician performing an analysis of a patient's teeth often finds multiple conditions that require treatment. If polishing is done correctly multiple types of paste in multiple paste holders must be used to treat these various conditions. Thus, a clinician either uses a paste that is appropriate for most of the conditions presented by the patient, but may not be adequate or appropriate for some conditions faced by the patient, or the clinician uses multiple prophy pastes, thereby wasting large amounts of prophy paste and increasing the cost of treatment. Therefore, a need exists for a prophylaxis paste holder dispenser that contains multiple prophylaxis pastes that are effective to treat different dental conditions.

### SUMMARY OF THE INVENTION

According to one embodiment, a dental prophylaxis paste holder dispenser comprises a first prophylaxis paste and a second prophylaxis paste. The first prophylaxis paste has a first abrasive agent. The second prophylaxis paste has a second abrasive agent. The first abrasive agent has a first material property and the second abrasive agent has a second material property. The first material property differs from the second material property.

According to another embodiment, a dental prophylaxis paste holder dispenser comprises a first prophylaxis paste and a second prophylaxis paste. The first prophylaxis paste has a first additive agent. The second prophylaxis paste has a second additive agent. The first additive agent has a first material property and the second additive agent has a second material property. The first material property differs from the second material property.

### BRIEF DESCRIPTION OF THE DRAWINGS

A better understanding of the present invention can be obtained by considering the following detailed description and the accompanying drawings in which:

FIG. 1 is a top view of a prophylaxis paste holder dispenser according to one embodiment;

FIG. 2 is a cross-sectional view of the prophylaxis paste holder dispenser of FIG. 1 taken through line 2-2

FIG. 3 is a top view of a prophylaxis paste holder dispenser according to another embodiment;

FIG. 4 is a cross-sectional view of the prophylaxis paste holder dispenser of FIG. 3 taken through line 4-4;

FIG. 5 is a top view of a prophylaxis paste holder dispenser according to a further embodiment;

FIG. 6 is a cross-sectional view of the prophylaxis paste holder dispenser of FIG. 5 taken through line 6-6;

FIG. 7 is a top view of a prophylaxis paste holder dispenser according to yet another embodiment;

FIG. 8 is a cross-sectional view of the prophylaxis paste holder dispenser of FIG. 7 taken through line 8-8;

FIG. 9 is a top view of a prophylaxis paste holder dispenser according to yet a further embodiment;

FIG. 10 is a cross-sectional view of the prophylaxis paste holder dispenser of FIG. 9 taken through line 10-10;

FIG. 11 is a flow chart depicting a method of selecting a prophylaxis paste holder dispenser;

FIG. 12 is a top view of a prophylaxis paste holder dispenser according to still yet another embodiment; and

FIG. 13 is a cross-sectional view of the prophylaxis paste holder dispenser of FIG. 12 taken through line 13-13.

### DETAILED DESCRIPTION

While the present invention is susceptible of many different embodiments, there is shown in the drawings and will herein be described in detail preferred embodiments of the invention with the understanding that the present disclosure is to be considered an exemplification of the principles of the invention and is not intended to limit the broad aspect of the invention to the embodiments illustrated.

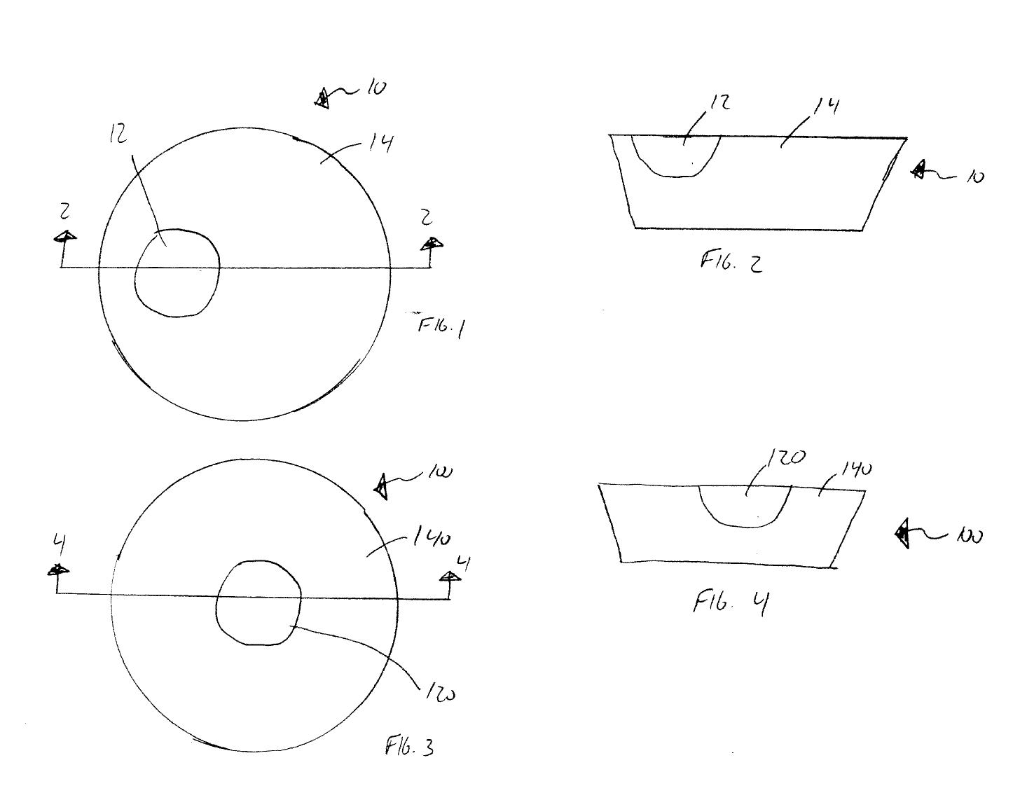

One embodiment of prophylaxis (or prophy) paste holder dispenser 10 of the present invention is generally shown in FIGS. 1 and 2. The prophy paste holder dispenser 10 contains a first prophylaxis paste 12 and a second prophylaxis paste 14. The first prophylaxis paste 12 and the second prophylaxis paste 14 are both accessible to a prophy cup of a dental prophylaxis angle. As shown in FIG. 1, the first prophy paste 12 has a generally circular shaped top surface. The first prophy paste 12 is also shown as being offset from the center of the prophy paste holder dispenser. It is contemplated that the first prophy paste 12 may have an alternative shaped top surface, such as square, oval, rectangular, and the like.

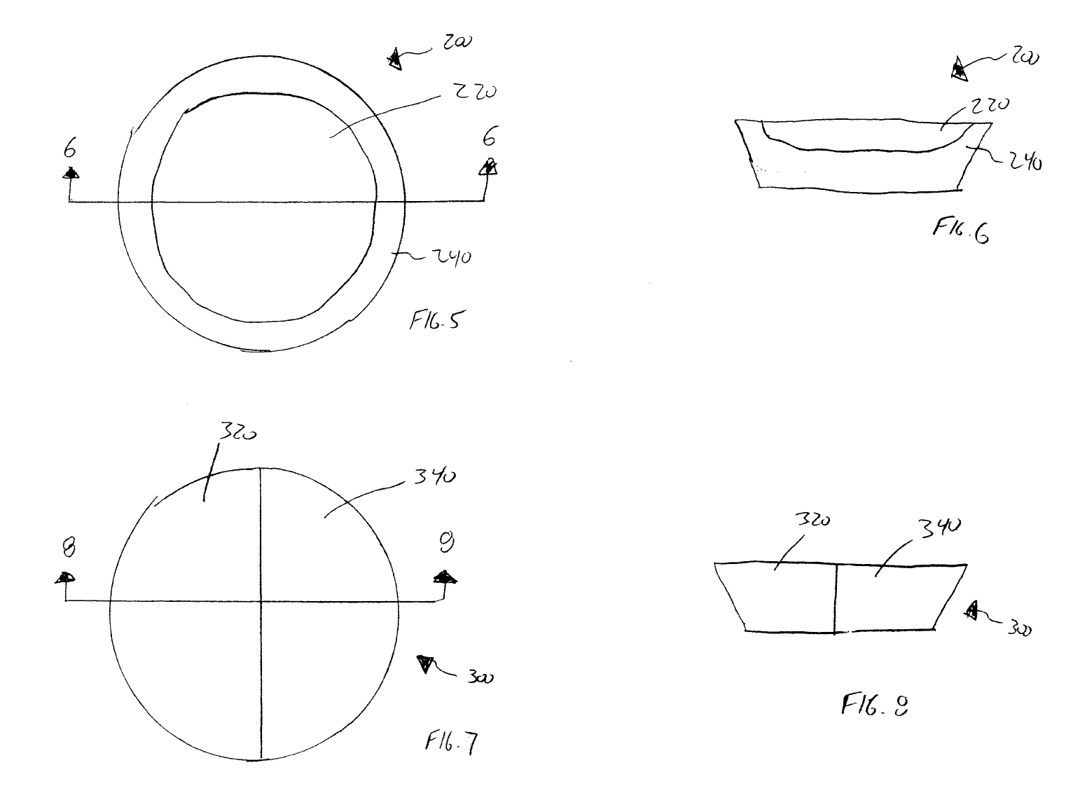

It is further contemplated that a first prophy paste 120 may be centered in a prophy paste holder dispenser 100, above the second prophy paste 140, as shown in FIGS. 3 and 4.

FIGS. 1-4 show that the clinician may select the first prophy paste 12, 120 to treat a first portion of a patient's mouth, and may also select the second prophy paste 14, 140 to treat a second portion of the patient's mouth, or the same portion of the patient's mouth. Alternatively, the clinician may select to use the first prophy paste 12, 120 over the patient's entire mouth to treat a first condition, and subsequently use the second prophy paste 14, 140 over the patient's entire mouth to treat a second condition.

As can be seen in FIGS. 1-4, the first prophy paste 12, 120 has a smaller surface area near a top portion of the prophy paste holder dispenser 10, 100 than the second prophy paste 14, 140. It is additionally contemplated that the size of the surface area of a first prophy paste 220 near a top portion of the prophy paste holder 200 may be larger than a second prophy paste 240, as shown in FIGS. 5 and 6.

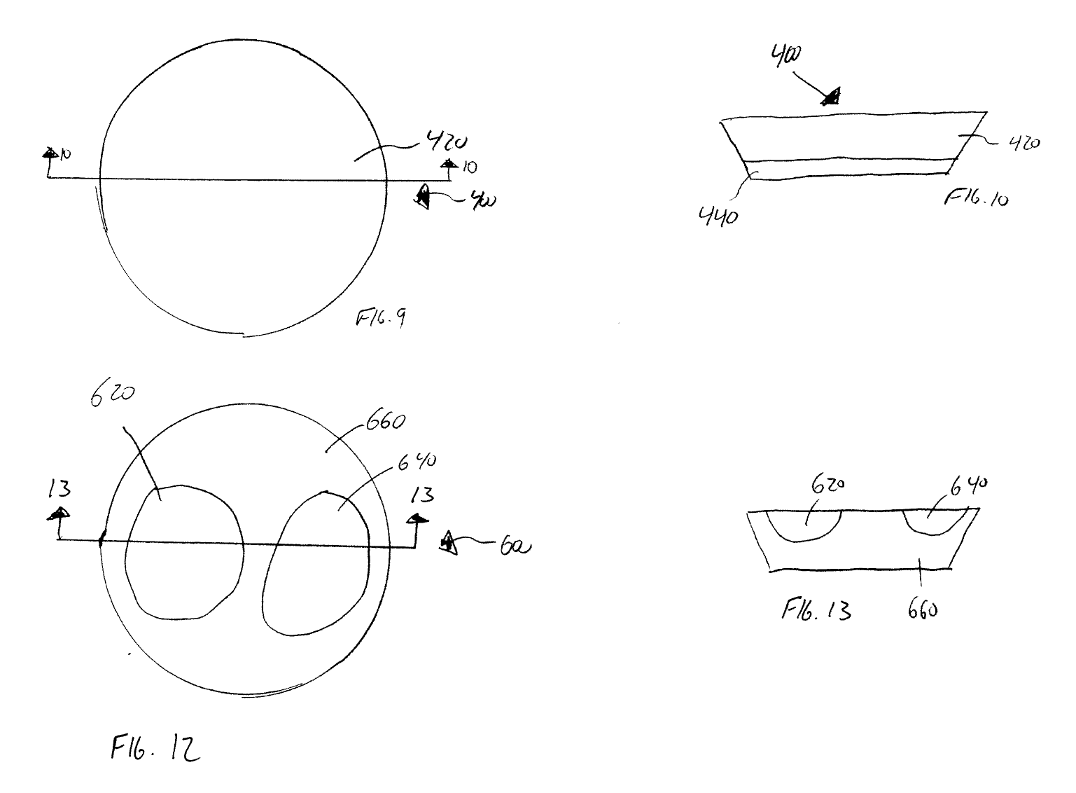

While FIGS. 1-6 show that a greater amount of the second prophy paste 14 is found in the prophy paste holder dispenser 10 than the first prophy paste 12, it is also contemplated that generally identical amounts of a first prophy paste 320 and the second prophy paste 340 may be provided in a prophy paste holder dispenser 300 as shown in FIGS. 7 and 8. FIGS. 7 and 8 show that the first prophy paste 320 and the second prophy paste 340 are disposed in a side by side arrangement and run from a bottom of the prophy paste holder dispenser 300 to a top of the prophy paste holder dispenser 300.

FIGS. 9 and 10 show an even further embodiment with a prophy paste holder dispenser 400 that contains a first prophy paste 420 and a second prophy paste 440. The first prophy paste 420 is disposed on top of the second prophy paste 440. In such an embodiment, the clinician would utilize the first prophy paste 420 to treat a first condition within the patient's mouth, such as for stain removal, and would use the second prophy paste to treat a second condition within the patient's mouth, such as polishing the patient's teeth, or whitening the patient's teeth. As shown in FIGS. 9 and 10, more of the first prophy paste 420 is provided compared to the second prophy paste 440.

The first prophy paste 12, 120, 220, 320, 420 and the second prophy paste 14, 140, 240, 340, 440 have different material properties and are chosen and prepared so that they generally stay separated from each other while stored in the holder dispenser. The viscosity of the first prophy paste 12, 120, 220, 320, 420 and the second prophy paste 14, 140, 240, 340, 440 prevent the pastes from mixing. For instance, the first prophy paste 12 and the second prophy paste 14 may contain different abrasives, or different particle sizes of the same abrasive. For example, the first prophy paste 12 may contain silica, and the second prophy paste 14 may contain pumice. Silica used in prophy paste may also be referred to as silica dioxide, or sand. Silica is used in many toothpastes. Silica often is utilized to treat heavily stained teeth since silica has a high cleaning capability.

A variety of forms of silica may be used depending on a patient's needs, such as aluminum silicates, zirconium silicates, and sodium-potassium aluminum silicate. Aluminum silicates are used to clean and polish dental enamel. Aluminum silicates typically have a Mohs hardness level of 2. Zirconium silicates, also known as Zircon, has a Mohs hardness level between 6.5 and 7.5. Zirconium silicates are known to reduce reformation of plaque, pellicle, and staining on enamel when compared to a pumice abrasive. Zirconium silicates are also known to reduce roughness of dental enamel surfaces compared to other abrasives. Sodium-potassium aluminum silicate has a Mohs hardness of between 6 and 7. Sodium-potassium aluminum silicate is known to clean tooth surfaces with low abrasion and high cleaning capability.

As mentioned above, the second prophy paste 14 may contain pumice as an abrasive. Pumice, sometimes called flour of pumice, is a common abrasive utilized in the dental industry during prophylaxis. Pumice is mainly silicon dioxide (SiO₂) or a metal oxide bound with silicon dioxide, such as aluminum oxide (Al₂O₃), calcium oxide (CaO), or magnesium oxide (MgO). Pumice is also refereed to as volcanic glass, as pressurized rock extruded from volcanoes is a common source of pumice. Pumice has a Mohs hardness value of between 6 and 7. When used in a prophy paste, pumice is also graded based on the size of the particles, such as fine, medium, and coarse. Pumice is a useful abrasive for oral biofilm and stain removal. Pumice also is appropriate for use on a variety of surfaces that may be found in a patient's mouth, such as tooth enamel, gold foil, dental amalgam, and acrylic resin.

Thus, in an embodiment like that shown in FIG. 1, a clinician may utilize the second prophy paste 14 with pumice as the abrasive in order to perform general stain removal and polishing, and use the first prophy paste 12 with a silica as the abrasive for cleaning teeth. Alternatively, the first prophy paste 120 may contain pumice as the abrasive and the second prophy paste 140 may contain silica as the abrasive.

It is also contemplated that other abrasives may also be used. For instance, a prophy paste containing white sapphire may be utilized to remove stains and restore luster to porcelain and composite materials within a patient. Diamond could also be used in a prophy paste. Diamond has a Mohs hardness value of 10 and is not appropriate for use on dental enamel or dentin, but diamond is known as an abrasive that will impart luster and gloss on porcelain, ceramic, and resin-based materials. Sodium bicarbonate is also an abrasive that is contemplated for use. Sodium bicarbonate is useful as a cleaning agent in dentifrices for oral biofilm and stain removal. Sodium bicarbonate has a Mohs hardness of 2.5. Calcium carbonate is yet another example of an abrasive that may be used in a prophy paste. Calcium carbonate is used for oral biofilm and stain removal, and is a mild abrasive that may be used on tooth enamel, gold foil, amalgam, and plastic. Calcium carbonate has a Mohs hardness level of 3. Thus, it is clear that a wide variety of abrasives may be utilized in the first prophy paste 12 and the second prophy paste 14, depending on the clinical needs of a the patient. Still another contemplated abrasive is feldspar, which had a Mohs hardness of about 6.

It is further contemplated that the first prophy paste 12 may contain pumice that has a fine particle size, while the second prophy paste 14 may contain pumice with a coarse particle size. Thus, the first prophy paste 12 with fine particle size pumice may be used for general cleaning and polishing, while the coarse particle size pumice in the second prophy paste 14 may be used for cleaning of heavily stained areas of the patient's teeth.

In addition to a variety of abrasives, a number of different additives may also be added to the first prophy paste 12 and the second prophy paste 14. Examples of additives that may be utilized include, but are not limited to, potassium nitrate, sodium fluoride, stannous fluoride, sodium monofluoride phosphate, amorphous calcium phosphate, hydrogen peroxide, carbide peroxide, calcium, potassium, hydroxyapatite, and/or zinc.

Sodium Fluoride, Stannous Fluoride, Sodium Monofluoride Phosphate and Stannous Sodium Hexametaphosphate are all commonly used fluoride agents that are in dental products, and prophy pastes. Fluoride is commonly used to prevent dental caries by remineralizing tooth surfaces, inhibiting demineralization, and inhibiting bacterial activity in a variety of professional dental products. In its natural form, fluoride occurs in tissues and is stored in bones and teeth. It's usage in dental products, produces fluorapatite, a form of hydroxyapatite. Hydroxyapatite is the main mineral of teeth and bones. Fluorapatite is a less soluble apatite and more resistant to acid attacks. This resistance is what helps with caries prevention.

Antimicrobial agent supplements have potential to further increase the microbial reduction that polishing provides when used in prophy pastes. Triclosan, Zinc, Povidone-Iodine, Chlorhexidine and Chlorine Dioxide are all commonly used chemistries that have some antimicrobial benefits. Triclosan is a broad spectrum antimicrobial agent that has anti-plaque and anti-gingivitis characteristics. Chlorhexidine is an antimicrobial agent that helps to treat of gingivitis and inflammation. It works by disrupting the integrity of the bacteria's cellular membrane. Another agent that has received much attention for its antimicrobial benefits is Povidone-Iodine. In research, the use of Povidone-Iodine has been shown to help to decrease the advancement of dental caries in school-aged children. Chlorine dioxide is an oxidizing agent that has been shown to being effect against gram positive and gram negative bacteria. Antimicrobial chemistries may be a beneficial additive to prophy pastes.

Prophy pastes may also contain tooth building block elements and compounds such as Calcium, Phosphate, Hydroxyapatite, Fluoride and Sodium might also be prospective additive options. Hydroxyapatite ((Ca₁₀(PO₄)₆(OH)₂) is the main component of teeth, bones and calculus. Products with calcium phosphate have been shown to make hydroxyapatite in the presence of saliva. These compounds may increase tooth luster and block dentinal tubules for decreased dentinal hypersensitivity. Other compounds that mimic natural tooth minerals may also be utilized in prophy paste to reduce sensitivity, increasing luster, and potentially remineralize teeth.

Potassium salts, commonly potassium nitrate, potassium citrate, and potassium chloride, have been utilized to reduce dentinal hypersensitivity in different home care and professional dental products, and may thus, be utilized in prophy pastes. Potassium ions diffuse into dentinal tubules and reduce interdental excitability by changing membrane potential.

Depending on a condition of the patient's teeth, prophy pastes that contain different additives may be appropriate. For instance, if a patient has an area that has caries, or tooth decay, a fluoride additive may be suitable for the second prophy paste 14, and if the patient also has a region with heavy stains, hydrogen peroxide may be an appropriate additive for the first prophy paste 12.

Additional additives may also be utilized including, but not limited to, calcium ions, calcium salt, fluoride ions, fluoride salt, carbonate ions, carbonate salts, phosphate ions, phosphate salt, amorphous calcium phosphate fluoride, amorphous calcium carbonate phosphate, calcium phosphate, calcium carbonate, phosphate salts, amorphous tricalcium phosphate, and arginine.

As described in connection with FIGS. 1-10, each of the first prophy paste 12, 120, 220, 320, 420 and the second prophy paste 14, 140, 240, 340, 440 are separate and stratified layers. That is, the first prophy paste is not intended to be mixed with the second prophy paste, although during use it is possible for some mixing to occur. The first prophy paste is intended to treat a first condition within the patient's mouth, while the second prophy paste is intended to treat a second condition in the patient's mouth.

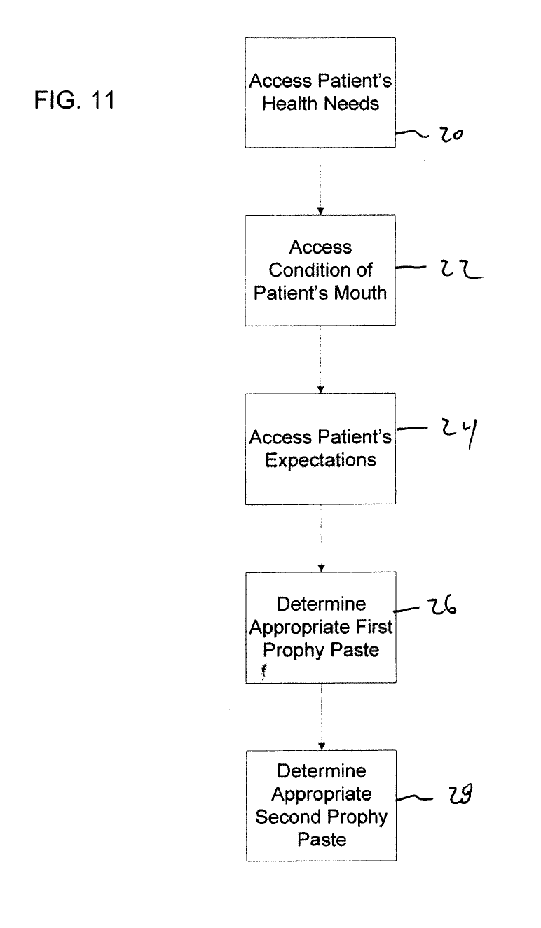

FIG. 11 shows a flow chart depicting a process of selecting a prophylaxis paste holder having a first prophy paste and a second prophy paste. In order to determine what abrasives and additives are appropriate for use with a patient, a clinician assesses the patient's health needs, step 20, the condition of the patient's mouth, step 22, and the patient's expectations of the treatment, step 24.

To assess the patient's health needs, as shown at step 20, the clinician evaluates a patient's mouth and teeth for a variety of factors. For instance, the clinician may determine that the patient has sensitive or hypersensitive teeth. A desensitizing prophy paste would be appropriate for a patient with hypersensitive teeth, so as to make the patient more comfortable during treatment. A patient may also be at a high risk for caries, also known as tooth decay or cavities. If a patient has high risk for caries, a fluoride containing prophy paste would be appropriate in order to treat the patient's teeth and reduce the risk of caries. A variety of fluorides, such as sodium fluoride, stannous fluoride, and monosodium fluoride may be utilized on a prophy paste. In addition to fluoride, other teeth remineralizing, desensitizing, or antimicrobial compounds may also be used in a prophy paste of a patient at high risk for caries. Further, a patient heavy staining on their teeth may be treated by a prophy paste that is abrasive enough to remove the staining. A patient with heavy staining may also be treated with a prophy paste that cleans via chemical action, such as a hydrogen peroxide containing prophy paste, or a prophy paste containing a bleaching agent. Finally, a patient with minimal staining may be treated with a prophy paste with a mild abrasive, such as pumice.

The clinician also will evaluate a condition of the patient's mouth in order to select an appropriate prophy paste, as shown at step 22. A patient with cosmetic or restorative materials in their mouth may require a particular abrasive in the prophy paste. If restoratives are not treated with appropriate abrasives, the longevity of the restorative may be compromised. For instance, certain abrasives may roughen a surface of the restorative and allow stains to form and biofilm growth to occur. Other restoratives, such as ceramic and porcelain, may be treated with prophy paste having very abrasive materials, like diamond, in order to improve the appearance of the restorative. Thus, depending on the materials used in restoratives, differing abrasives in the first prophy paste 12 and the second prophy paste 14 may be appropriate.

Finally, the clinician will access the patient's expectations from the treatment, as shown at step 24. A patient may express a desire to have a “clean” feeling mouth. In such a scenario, a prophy paste that removes biofilm and pellicle and provides a smooth surface after polishing is appropriate. If the patient expresses a desire for whiter teeth, a prophy paste with a bleaching agent may be selected.

Thus, based upon the patient's health needs and expectations a variety of different abrasives or additives for prophy paste may be appropriate to treat the patient, and the clinician selects a first prophy paste, as shown at step 26, and selects a second prophy paste, as shown at step 28. Thus, the use of the prophy paste holder dispenser 10 that contains the first prophy paste 12 and the second prophy paste 14, where the first prophy paste 12 and the second prophy paste 14 have different properties, such as different abrasives, or different additives, allows the clinician to better treat the variety of conditions within the patient's mouth. Therefore it is contemplated that the clinician will perform the evaluation of the patient's health needs, the condition of the patient's mouth, and the patient's expectations, and select a prophy paste holder dispensers 10 containing the first prophy paste 12 and the second prophy paste 14 that are best suited to treat the patient.

It is contemplated that a clinician may have a supply of prophy paste holder dispensers that have varying combinations of abrasives and additives in the a first prophy paste and a second prophy paste, so that the clinician may select a prophy paste holder dispensers best suited to treat a patient. Further, it is contemplated that custom prophy paste holder dispensers may be designed for a patient that contains a first prophy paste and a second prophy paste selected to treat clinical needs of that particular patient. Such a custom prophy paste holder dispensers may be created based on historical clinical needs of a patient, the treatment required on a preceding visit, or it is also contemplated that the prophy paste holder dispensers may be created after a clinician has performed an initial evaluation of a patient during a clinical visit.

The first prophy paste 12 and the second prophy paste 14 are preferably dispensed into the prophy paste holder dispensers 10 using a nozzle manifold. The nozzle manifold is used in conjunction with an All-Fill B400 filling system, provided by ALL-FILL, Inc. of Exton, Pa. The nozzle manifold provides a moment of negative pressure to the paste so as to control an amount of paste being distributed to the prophy paste holder dispensers 10. Prophy paste is typically thixotropic, in that the paste becomes less viscous as shear force is applied. Paste within the filling system has a thick consistency until an auger within the filling system that feeds the paste towards nozzles of the nozzle manifold to place the paste into the prophy paste holder dispenser 10 acts on the paste. The shear force of the auger thins the paste. Typically, when the paste is made less viscous by the auger it can become difficult to dispense into the prophy paste holder dispensers. Because of this, the nozzles are designed to have tapered dimensions in order to more precisely guide and place the paste within the paste holder dispensers 10. As the paste is being dispensed into the prophy paste holder dispensers 10, a negative pressure is applied to the paste within the nozzle manifold, to stop the flow of paste out of the nozzle. The negative pressure is applied by a vacuum generator in fluid communication with the nozzle manifold. The amount of negative pressure provided to the nozzle manifold varies somewhat based on properties of the prophy paste and atmospheric conditions, but is generally between about 0.25 bar and about 0.75 bar, and is most preferably between about 0.4 bar and 0.5 bar. The vacuum generator has a control valve in order to control an amount of vacuum provided at the nozzle manifold, although it is contemplated that a control valve could alternatively be provided at the nozzle manifold. As the paste is dispensed, the control valve is positioned to allow the vacuum generator to provide negative pressure to the nozzle manifold and the negative pressure at the nozzle manifold retracts the remaining paste in the nozzle allowing for precise and clean placement of the paste into the paste holder dispensers 10. The nozzle manifold thus allows accurate control of an amount of prophy paste placed into the prophy paste holder dispenser 10. The tapered nature of the nozzles further allows for accurate placement within the prophy paste holder dispenser 10 of the prophy paste. Therefore, the prophy paste holder dispenser 10 may be supplied to a first nozzle manifold having the first prophy paste 12, so that a desired amount of the first prophy paste 12 is placed into a desired location of the prophy paste holder dispenser 10. Next, the prophy paste holder dispenser 10 is provided to a second nozzle manifold having the second prophy paste 14. A desired amount of the second prophy paste 14 is then placed into the prophy paste holder dispenser 10 at a desired location. Thus, the use of the tapered nozzle and the nozzle diaphragm that includes a negative pressure that acts on the paste allows layers of the first prophy paste 12 and the second prophy paste 14 to be placed into the prophy paste holder dispenser 10.

It is also contemplated that additional layers of additional prophy pastes may be placed into a prophy paste holder dispenser. For example, FIGS. 12 and 13 show a prophy paste holder dispenser 600 having a first prophy paste 620, a second prophy paste 640, and a third prophy paste 660. As shown in FIG. 12, the first prophy paste 620 and the second prophy paste 640 are generally layered above the third prophy paste 660. However, it is contemplated that any of the prophy paste arrangements discussed above in connection with FIGS. 1-10 may also be utilized when additional layers of prophy paste are added to a prophy paste holder dispenser.

While the specific embodiments have been illustrated and described, numerous modifications come to mind without significantly departing from the spirit of the invention and the scope of protection is only limited by the scope of the accompanying Claims.

1. A dental prophylaxis paste holder dispenser comprising:
a first prophylaxis paste having a first abrasive agent and a first border; and
a second prophylaxis paste having a second abrasive agent and a second border, the first border of the first paste contacting at least a portion of the second border of the second paste;
wherein the first abrasive agent has a first material property and the second abrasive agent has a second material property, the first material property being different than the second material property.

2. The dental prophylaxis paste holder dispenser of claim 1, wherein the first material property comprises particle size of the first abrasive agent and the second material property comprises particle size of the second abrasive agent.

3. The dental prophylaxis paste holder dispenser of claim 2, wherein the first material property comprises a coarse particle size, and the second material property comprises a fine particle size.

4. The dental prophylaxis paste holder dispenser of claim 1, wherein the first material property comprises a material of the first abrasive agent and the second material property comprises a material of the second abrasive agent.

5. The dental prophylaxis paste holder dispenser of claim 2, wherein the material of the first abrasive agent comprises pumice, and the material of the second abrasive agent comprises silica.

6. The dental prophylaxis paste holder dispenser of claim 5, wherein the silica comprises aluminum silicate

7. The dental prophylaxis paste holder dispenser of claim 5, wherein the silica comprises zirconium silicate.

8. The dental prophylaxis paste holder dispenser of claim 5, wherein the silica comprises sodium-potassium aluminum silicate.

9. The dental prophylaxis paste holder dispenser of claim 4, wherein the first abrasive agent and the second abrasive agent are selected from the group consisting of aluminum silicate, zirconium silicate, pumice, white sapphire, diamond, sodium bicarbonate, sodium-potassium aluminum silicate, feldspar, and calcium carbonate.

10. The dental prophylaxis paste holder dispenser of claim 1, wherein a top surface area of the first prophy paste is smaller than a top surface area of the second prophy paste.

11. The dental prophylaxis paste holder dispenser of claim 1, wherein a top surface area of the first prophy paste is larger than a top surface area of the second prophy paste.

12. The dental prophylaxis paste holder dispenser of claim 1, wherein a top surface area of the first prophy paste is generally identical to a top surface area of the second prophy paste.

13. A dental prophylaxis paste holder dispenser comprising:
a first prophylaxis paste having a first additive agent and having a first border; and
a second prophylaxis paste having a second additive agent and having a second border, the first border of the first paste contacting at least a portion of the second border of the second paste;
wherein the first additive agent has a first material property and the second additive agent has a second material property, the first material property being different than the second material property.

14. The dental prophylaxis paste holder dispenser of claim 13, wherein the first material property comprises a type of additive agent and the second material property comprises a type of additive agent.

15. The dental prophylaxis paste holder dispenser of claim 14, wherein the first additive agent comprises fluoride and the second additive agent comprises a bleaching agent.

16. The dental prophylaxis paste holder dispenser of claim 15, wherein the fluoride comprises sodium fluoride.

17. The dental prophylaxis paste holder dispenser of claim 15, wherein the fluoride comprises stannous fluoride.

18. The dental prophylaxis paste holder dispenser of claim 15, wherein the bleaching agent comprises hydrogen peroxide.

19. The dental prophylaxis paste holder dispenser of claim 13, wherein a top surface area of the first prophy paste is smaller than a top surface area of the second prophy paste

20. The dental prophylaxis paste holder dispenser of claim 13, wherein a top surface area of the first prophy paste is larger than a top surface area of the second prophy paste.

21. The dental prophylaxis paste holder dispenser of claim 13 wherein a top surface area of the first prophy paste is generally identical to a top surface area of the second prophy paste.

22. The dental prophylaxis past holder dispenser of claim 13, wherein the first additive agent and the second additive agent are selected from the group consisting of potassium nitrate, sodium fluoride, stannous fluoride, sodium monofluoride phosphate, amorphous calcium phosphate, hydrogen peroxide, carbide peroxide, calcium, potassium, hydroxyapatite, zinc, triclosan, povidone-iodine, chlorhexidine, chlorine dioxide, potassium citrate, potassium chloride, calcium ions, calcium salt, fluoride ions, fluoride salt, carbonate ions, carbonate salts, phosphate ions, phosphate salt, amorphous calcium phosphate fluoride, amorphous calcium carbonate phosphate, calcium phosphate, calcium carbonate, amorphous tricalcium phosphate, and arginine.
